(19) United States
(12) Patent Application Publication
(10) Pub. No.: US 2015/0241033 A1
(43) Pub. Date: Aug. 27, 2015

(54) Lamp Apparatus and Luminaire

(71) Applicant: Toshiba Lighting & Technology Corporation, Yokosuka-shi (JP)

(72) Inventors: Takayoshi Kurita, Yokosuka-shi (JP); Kozo Ogawa, Yokosuka-shi (JP); Yusuke Shibahara, Yokosuka-shi (JP); Hiroshi Takenaga, Yokosuka-shi (JP)

(73) Assignee: Toshiba Lighting & Technology Corporation, Yokosuka-shi (JP)

(21) Appl. No.: 14/489,516

(22) Filed: Sep. 18, 2014

(30) Foreign Application Priority Data
Feb. 24, 2014 (JP) 2014-033417

(51) Int. Cl. F21V 17/06; F21V 23/02; F21K 99/00

(52) U.S. Cl. CPC F21V 17/06; F21K 9/13; F21K 9/50; F21V 23/023; F21Y 2101/02

(57) ABSTRACT

According to one embodiment, a lamp apparatus includes a housing, a light-emitting module, a lens and a cover. The housing includes a concave part and a support part protruding into the concave part from an inner peripheral surface of the concave part. The light-emitting module includes a light-emitting element and a board on which the light-emitting element is mounted, and is disposed in the concave part. The lens includes a flange part located at a peripheral part and arranged on the support part, and is arranged in the concave part. The cover holds the flange part of the lens between itself and the support part and is attached to the housing.

### INCORPORATION BY REFERENCE

The present invention claims priority under 35 U.S.C. §119 to Japanese Patent Application No. 2014-033417 filed on Feb. 24, 2014. The content of the application is incorporated herein by reference in its entirety.

### FIELD

Embodiments described herein relate generally to a lamp apparatus using a lens and a luminaire using the lamp apparatus.

### BACKGROUND

Hitherto, there is a lamp apparatus using an LED as a light-emitting element and using a lens to control luminous intensity distribution of light incident from the LED.

In the lamp apparatus using such lens, the positional relation between the lens and the LED is important in order to obtain stable specific luminous intensity distribution characteristics.

Although there is a structure in which positioning is performed by causing a lens to contact a board on which an LED is mounted, a load is applied to the board, and there is a fear that the board is damaged or a soldered part is broken.

Thus, certain positioning and fixing of a lens relative to a light-emitting element is desired without applying a load to a board.

### BRIEF DESCRIPTION OF THE DRAWINGS

FIG. 1 is a sectional view of a lamp apparatus of a first embodiment.

FIG. 2 is a perspective view of a decomposed state of the lamp apparatus.

FIG. 3 is a perspective view of an assembled state of the lamp apparatus.

FIG. 4 is a sectional view of a luminaire using the lamp apparatus.

FIG. 5 is a sectional view of a lamp apparatus of a second embodiment.

### DETAILED DESCRIPTION

In general, according to one embodiment, a lamp apparatus includes a housing, a light-emitting module, a lens, a cover, a power-supply part and a lighting circuit. The housing includes a concave part opening at one end side, and a support part protruding into the concave part from an inner peripheral surface of the concave part. The light-emitting module includes a light-emitting element and a board on which the light-emitting element is mounted, and is disposed in the concave part. The lens includes a flange part located at a peripheral part at one end side and arranged on one end side of the support part, is arranged in the concave part and controls luminous intensity distribution of light incident from the light-emitting element. The cover is annular, holds the flange part of the lens between itself and the support part and is attached to the housing. The power-supply part is arranged at the other end side of the housing. The lighting circuit is arranged between the housing and the power-supply part.

According to the lamp apparatus, the lens can be expected to be certainly positioned and fixed relative to the light-emitting element.

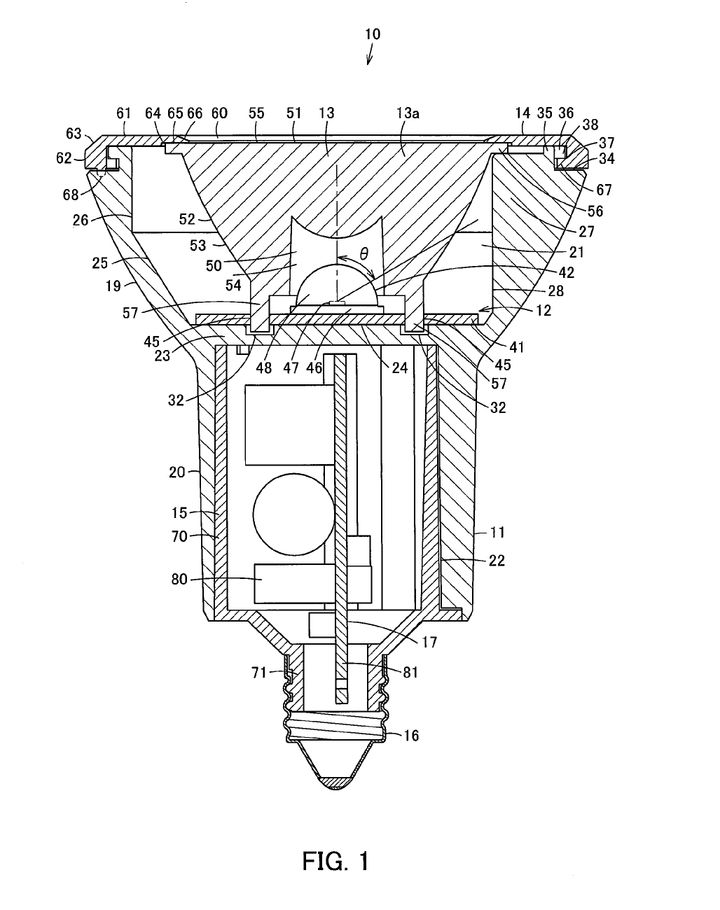

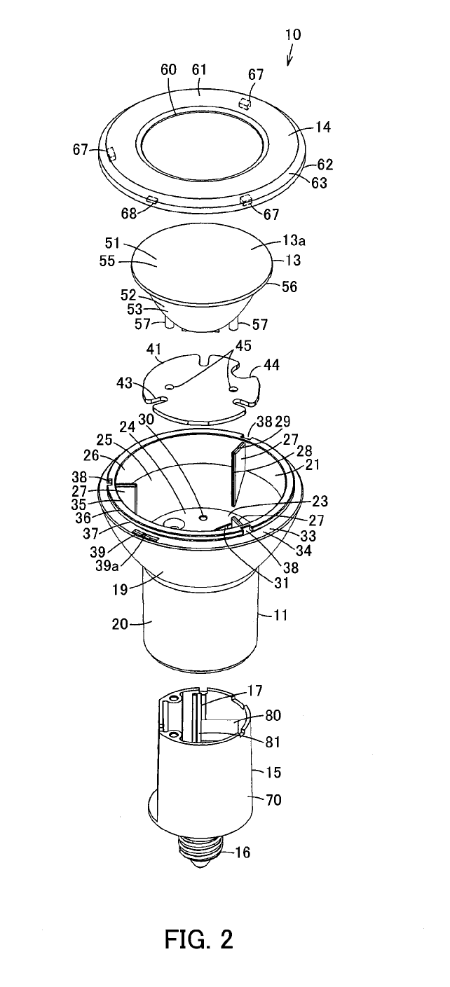

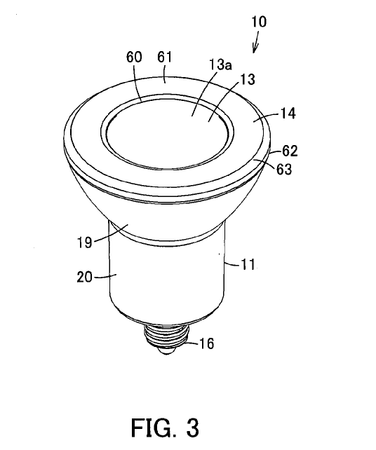

Hereinafter, a first embodiment will be described with reference to FIG. 1 to FIG. 4.

FIG. 1 to FIG. 3 show a lamp apparatus 10 which is a bulb-type lamp. The lamp apparatus 10 includes a housing 11, and includes a light-emitting module 12, a lens 13 and a cover 14, which are arranged at one end side (one end side in a center axis direction of the lamp apparatus 10) of the housing 11, and further includes a case 15, a cap 16 as a power-supply part and a lighting circuit 17, which are arranged at the other end side of the housing 11.

The housing 11 is integrally formed of a metal material such as aluminum. A substantially hemispherical body part 19 expanding toward the one end side is formed at the one end side of the housing 11, and a cylindrical part 20 opening toward the other end side is formed at the other end side of the housing 11. The housing 11 is formed to approximate the shape of a so-called Ref Lamp.

A concave part (first concave part) 21 opening at the one end side of the housing 11 is formed at the one end side of the housing 11. A concave part (second concave part) 22 opening at the other end side of the housing 11 is formed at the other end side of the housing 11. A partition part 23 is formed between the concave parts 21 and 22.

A flat attachment surface 24 formed of the surface of the partition part 23 at the one end side is formed at the bottom of the concave part 21. An inclined surface part 25 expanded and inclined from the attachment surface 24 is formed at a peripheral part of the concave part 21, and a cylindrical side surface part 26 is formed from the inclined surface part 25.

Plural support parts 27 protruding in the concave part 21 toward the center axis of the lamp apparatus 10 are formed on the side surface part 26 of the concave part 21. The support parts 27 are formed in rib shapes and are formed radially from the center axis of the lamp apparatus 10. Side parts 28 of the support parts 27 at the center side are formed along the center axis, and a diameter of an imaginary circle passing through the side parts 28 of the plural support parts 27 is larger than the attachment surface 24 and the light-emitting module 12. Further, positions of the side parts 28 of the plural support parts 27 are positions not in contact with the lens 13. Besides, support surfaces 29 for supporting the lens 13 are formed on surfaces of the support parts 27 at the one end side. The support surfaces 29 are positioned inside an end part of the housing 11 at the one end side, that is, the end part of the housing 11 at the one end side protrudes more than the support surfaces 29. In this embodiment, although the support parts 27 are arranged at equal intervals at three places of the concave part 21 in the peripheral direction, the support parts may be arranged at two places or four or more places.

The partition part 23 is provided with plural attachment holes 30 for screwing the light-emitting module 12 and a wiring hole 31 through which a wiring for electrically connecting the light-emitting module 12 and the lighting circuit 17 passes. Further, the partition part 23 is provided with plural escape parts 32. In this embodiment, the pair of escape parts 32 are formed at symmetrical positions relative to the center line of the partition part 23. The escape parts 32 are formed of circular recess parts recessed onto the surface side of the partition part 23 at the one end side, that is, onto the attachment surface 24 side. Incidentally, the escape parts 32 may be circular holes passing through the partition part 23.

A cover attachment part 33 to which the cover 14 is attached is formed at the one end side of the housing 11. A step part 34 formed on a surface of the housing 11 at the one end side is formed on the cover attachment part 33, and an annular protrusion part 35 is protrudingly provided on an inner peripheral side of the step part 34. A collar part 36 is protrudingly provided on an outer periphery of the protrusion part 35, and a groove part 37 is formed between the collar part 36 and the step part 34. Plural insertion grooves 38 communicating with the groove part 37 are formed in the collar part 36. The insertion grooves 38 are arranged at positions near the support parts 27 correspondingly to the positions of the support parts 27. A locking groove 39 for locking the cover 14 attached to the housing 11 is formed in the step part 34. A projection 39a is protrudingly provided at the center of the locking groove 39, one side of the projection 39a is formed to be an inclined surface, and the other side is formed to be a vertical surface.

Besides, the light-emitting module 12 includes a board 41, and a light-emitting element 42 mounted on the board 41.

The board 41 is made of a metal material such as aluminum or an insulating material such as ceramic into a disk shape. An insulating layer is formed on a mount surface as a surface of the board 41 at the one end side and a wiring pattern is formed on the insulating layer. The light-emitting element 42 is electrically connected to the wiring pattern by soldering or the like. An attachment groove 43 for screwing and a wiring groove 44 for wiring are formed in a peripheral edge part of the board 41. Through holes 45 for positioning the light-emitting element 42 to the lens 13 are formed in the inside of the board 41. In this embodiment, although the pair of through holes 45 are formed at symmetrical positions relative to the center axis of the board 41, three or more through holes may be formed at equal interval in the peripheral direction around the center axis of the board 41.

The board 41 is arranged on the attachment surface 24 of the housing 11 through an insulating sheet as a thin sheet of silicone resin, silicone rubber or the like having insulation properties, thermal conductivity and elasticity. The board 41 is thermally connected to the attachment surface 24 in an insulated state and is fixed by plural not-shown screws.

As the light-emitting element 42, a bullet-shaped light-emitting element is used in which an LED 47 is mounted on an element board 46, and the LED 47 is covered with a dome-shaped translucent member 48. The element board 46 is arranged on the board 41 and is electrically connected to the wiring pattern by soldering or the like. The LED 47 emits, for example, blue light, and the translucent member 48 contains a phosphor which is excited by the blue light emitted by the LED 47 and mainly emits yellow light. Accordingly, the surface of the translucent member 48 as the surface of the light-emitting element 42 becomes a light-emitting surface, and whitish illumination light is emitted from the light-emitting surface. Incidentally, as the light-emitting element 42, an SMD (Surface Mount Device) package or a COB (Chip On Board) module may be used, or another light-emitting element, such as an organic EL, other than the LED may be used.

The lens 13 is made of a material such as translucent synthetic resin or glass. The lens 13 includes an incident part 50 facing the light-emitting element 42 and provided at the other end side of the lens 13, an exit part 51 provided at one end side of the lens 13, and a reflection part 52 between the incident part 50 and the exit part 51. The lens 13 is a total reflection type lens which causes substantially all the light of the light-emitting element 42 incident from the incident part 50 to exit from the exit part 51.

The lens 13 includes a lens body 13a. The lens body 13a is formed to gradually expand from the incident part 50 side to the exit part 51 side, and the outer peripheral surface of the lens body 13a is formed in a curved surface (ellipsoid of revolution or paraboloid) to reflect the light toward the exit part 51. An outer peripheral surface of the lens body 13a is constructed as a reflection surface 53 of the reflection part 52. A part of the light-emitting element 42 is intruded into and arranged in the incident part 50 and the incident part includes an incident concave part 54 on which the light from the light-emitting element 42 is incident. The exit part 51 includes a flat exit surface 55 along a direction crossing (perpendicular) the center axis of the lamp apparatus 10.

A flange part 56 is formed at a peripheral part of the lens 13 at the one end side, that is, at a peripheral part of the exit part 51 (exit surface 55). A diameter of the flange part 56 is larger than the imaginary circle passing through the side parts 28 of the plural support parts 27 at the center side, and can be arranged on the support surfaces 29 of the support parts 27.

Plural leg parts 57 are provided at the other end side of the lens 13 protrudingly toward the other end side. That is, the leg parts 57 are provided at the outer diameter side of the incident part 50 protrudingly from the position of the inclined reflection part 52 toward the other end side. The leg part 57 is formed in a columnar shape. In this embodiment, although the pair of leg parts 57 are formed at symmetrical positions relative to the center axis of the lens 13, three or more leg parts may be protrudingly provided at equal intervals in the peripheral direction around the center axis of the lens 13. That is, the leg parts 57 of the lens 13, the through holes 45 of the board 41 and the escape parts 32 of the housing 11 have only to correspond to each other.

The length of the leg part 57 is such that in the assembled state of the lamp apparatus 10, the leg part passes through the through hole 45 of the board 41 and is arranged in the escape part 32 of the housing 11, however, the tip of the leg part 57 does not contact the housing 11. The diameter of the leg part 57 is slightly smaller than the through hole 45 of the board 41, and is smaller than the escape part 32 of the housing 11. Incidentally, the diameter of the escape part 32 is formed to be larger than the leg part 57 so that the non-contact state with the leg part 57 is kept. Besides, the connection position of the leg part 57 connected to the reflection part 52 of the lens body 13a is a position of 60° or more relative to the optical axis perpendicular to the LED 47 of the light-emitting element 42. That is, the leg part 57 is not provided on the reflection part 52 within the range of angle θ=60° of FIG. 1.

The cover 14 is made of a translucent material into an annular shape having an opening 60 at the center. As the translucent material, a material having a refractivity lower than the lens 13 or polycarbonate having a higher transmittance is used. A diffusion agent may be added to the translucent material so that the cover 14 has a light diffusion property.

The cover 14 includes an annular front surface part 61, an annular side surface part 62 formed at a peripheral part of the front surface part 61, and an inclined surface part 63 formed between the front surface part 61 and the side surface part 62.

A surface of the front surface part 61 at the one end side is formed in a flat shape. A recess part 64 in which the flange part 56 of the lens 13 is fitted is formed on a surface of the front surface part 61 at the other end side. A press part 65 in contact with a surface of the flange part 56 at the one end side is formed in the recess part 64. A peripheral part of the recess part 64 and a peripheral part of the flange part 56 do not contact each other and a gap is formed therebetween. An inclined surface 66 expanding from the other end side of the front surface part 61 to the one end side, that is, to the light exit direction is formed on the inner peripheral part of the front surface part 61. The inner peripheral part of the front surface part 61 is positioned nearer to the center side than the flange part 56 of the lens 13 and the support part 27, and covers the peripheral part of the exit surface 55 of the lens 13.

The side surface part 62 is fitted to the step part 34 of the housing 11. Plural attachment parts 67 are protrudingly provided on the inner peripheral surface of the side surface part 62 correspondingly to the plural insertion grooves 38 of the housing 11. The attachment parts 67 can be inserted into and extracted from the groove part 37 through the insertion grooves 38 of the housing 11, and when the cover 14 is rotated relative to the housing 11 in the state where the attachment parts are inserted in the groove part 37, the attachment parts are caught by the collar part 36 and are attached.

A locking part 68 is protrudingly provided on a surface of the side part 62 at the other end side, and the locking part is locked by the locking groove 39 when the cover 14 is rotated by a specified angle relative to the housing 11 from the position where the attachment parts 67 enter the groove part 37 through the insertion grooves 38 of the housing 11. When the locking part 68 is fitted in the locking groove 39, the locking part is locked in both the rotation direction at the time of mounting of the cover 14 and the rotation direction opposite to that at the time of mounting. In the attachment state of the cover 14 and the housing 11 in which the locking part 68 is fitted in the locking groove 39, the attachment part 67 is positioned in the vicinity of the support part 27 and is positioned within a range of, for example, 10° from the support part 27 in the peripheral direction.

The case 15 is made of an insulating material such as PBT resin into a cylindrical shape. The case 15 includes a cylindrical body part 70 attached to the concave part 22 of the housing 11, and a cap attachment part 71 which is continuous with the other end side of the body part 70 and protrudes from the concave part 22 of the housing 11.

The cap 16 is a power-supply part connectable to a socket for a general illumination bulb. The cap is an E-type cap in this embodiment and is attached to the cap attachment part 71 of the case 15.

The lighting circuit 17 converts AC power into specified DC power, and supplies the power to the light-emitting element 42 of the light-emitting module 12. The lighting circuit 17 includes a circuit board 81 on which plural circuit elements 80 constituting the circuit are mounted. The circuit board 81 is inserted along the axial direction of the case 15 and is housed in the case 15 over the body part 70 and the cap attachment part 71. The cap 16 is electrically connected to the input side of the lighting circuit 17. An electric wire for electrical connection to the light-emitting module 12 is electrically connected to the output side of the lighting circuit 17. The electric wire is wired through the wiring hole 31 of the housing 11 and the wiring groove 44 of the board 41.

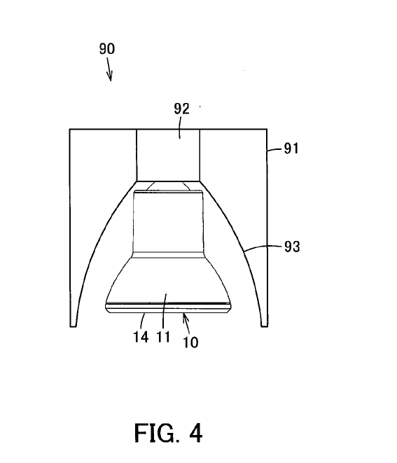

FIG. 4 shows a luminaire 90 using the lamp apparatus 10. The luminaire 90 is, for example, a downlight. The luminaire 90 includes a luminaire body 91. A socket 92 and a reflector 93 are disposed in the body 91. The socket 92 is electrically connected with the cap 16 of the lamp apparatus 10 and can supply AC power to the lamp apparatus 10.

When the lamp apparatus 10 is assembled, the light-emitting module 12 is inserted in the concave part 21 of the housing 11, and the board 41 is screwed and fixed to the attachment surface 24. In the state where the board 41 is fixed to the housing 11, the through holes 45 of the board 41 are arranged to face the escape parts 32.

The lens 13 is inserted in the concave part 21 of the housing 11, the respective leg parts 57 of the lens 13 are inserted in the respective through holes 45 of the board 41, and the flange part 56 of the lens 13 is arranged on the support parts 27.

At this time, since the leg parts 57 are formed to be long so that the leg parts pass through the board 41, the leg parts 57 can be easily inserted into the through holes 45 of the board 41 positioned at the depth side of the concave part 21 of the housing 11. Besides, since the leg parts 57 inserted in the through holes 45 guide the insertion direction of the lens 13, the lens 13 can be prevented from contacting the light-emitting element 42.

The leg parts 57 are inserted in the through holes 45 of the board 41, so that the lens 13 and the board 41 are positioned in the direction parallel to the surface of the board 41, and as a result, the lens 13 and the light-emitting element 42 are positioned. Further, the flange part 56 of the lens 13 is arranged on the support parts 27, so that the lens 13 and the light-emitting element 42 are positioned through the housing 11 in the center axis direction of the lamp apparatus 10.

Since the leg parts 57 passing through the through holes 45 of the board 41 intrude into the escape parts 32 of the housing 11, the leg parts do not contact the housing 11, and influence on the positioning of the lens 13 and the board 41 can be prevented from occurring.

Subsequently, the locking part 68 of the cover 14 is aligned with the locking groove 39 of the housing 11, and the respective attachment parts 67 are aligned with the respective insertion grooves 38 of the housing 11, and then the cover 14 is attached on the housing 11 and the lens 13. By this, the locking part 68 enters the locking groove 39, the respective attachment parts 67 enter the position of the groove part 37 through the respective insertion grooves 38, and the side surface part 62 of the cover 14 is fitted to the step part 34 of the housing 11.

The cover 14 is rotated in the specified attachment direction relative to the housing 11, so that the locking part 68 moves in the locking groove 39, and the attachment parts 67 move to the groove part 37 and are caught by the collar part 36. The locking part 68 contacts the inclined surface of the projection 39a in the middle of movement in the locking groove 39, and the locking part 68 climbs over the projection 39a. As a result, the locking part 68 is locked between the inner wall of the locking groove 39 and the vertical surface of the projection 39a, and the rotation in the attachment direction of the cover 14 and in the detachment direction opposite to the attachment direction is restricted.

When the cover 14 is attached to the housing 11, the flange part 56 of the lens 13 is fitted in the recess part 64 of the cover 14, and the flange part 56 is held between the press part 65 of the cover 14 and the support part 27.

Subsequently, the case 15 in which the cap 16 and the lighting circuit 17 are assembled is inserted and fixed to the concave part 22 of the housing 11. Incidentally, after the case 15 and the like are first assembled in the housing 11, the light-emitting module 12 and the like may be assembled in the housing 11. In the process in which the light-emitting module 12 and the lighting circuit 17 are assembled in the housing 11, the light-emitting module 12 and the lighting circuit 17 are electrically connected by wiring.

When the lamp apparatus 10 is mounted in the socket 92 of the luminaire 90 and power is applied, the lighting circuit 17 supplies lighting power to the light-emitting element 42 of the light-emitting module 12, and the light-emitting element 42 emits light. The light emitted from the light-emitting element 42 is incident on the lens 13 from the incident part 50, and exits from the exit surface 55 of the lens 13 in a specified luminous intensity distribution direction.

Part of the light incident on the lens 13 is incident on the cover 14 from the vicinity of the flange part 56. When the cover 14 is made of a material having a lower refractivity than the lens 13, the light incident on the cover 14 is guided in the cover 14, and the whole cover 14 emits light, and the design property at the time of light emission can be improved. When the cover 14 is made of polycarbonate added with a diffusion agent, a higher effect of improving the design property at the time of light emission can be obtained.

The inner peripheral part of the front surface part 61 of the cover 14 is positioned nearer to the center side than the flange part 56 of the lens 13 and the support parts 27, and covers the peripheral part of the exit part 55 of the lens 13. Thus, although there is a possibility that light unevenness occurs in the vicinity of the boundary between the lens body 13a and the flange part 56, the light unevenness can be shielded by the cover 14.

Since the inclined surface 66 expanding from the other end side of the front surface part 61 to the one end side, that is, to the light exit direction is formed on the inner peripheral part of the front surface part 61 of the cover 14, the light emitted from the lens 13 is not shielded and the light loss by the cover 14 can be suppressed to the minimum. Incidentally, the inclined surface 66 is arranged across the lens body 13a and the flange part 56, so that the light which can cause the light unevenness can be made easily reflected to the outside direction of the cover 14 by the inclined surface 66.

Desired reflection cannot be obtained at the connection position of the leg part 57 connected to the reflection part 52 of the lens body 13a. However, the connection position of the leg part 57 is made the position within the range of 60° or more relative to the optical axis vertical to the LED 47 of the light-emitting element 42, so that the connection position of the leg part 57 is arranged at the position where the ratio of the light flux from the light-emitting element 42 is low, and the reduction in exit efficiency from the lens can be suppressed.

Besides, heat generated by the light-emitting element 42 at the time of light emission is conducted mainly from the board 41 to the partition part 23 of the housing 11, and is radiated from the outer surface of the housing 11 to the outer air.

In the lamp apparatus 10 of the embodiment, since the flange part 56 of the lens 13 is held between the support part 27 of the housing 11 and the cover 14, the lens 13 can be certainly positioned and fixed to the light-emitting element 42 through the housing 11. Thus, the lamp apparatus 10 can obtain stable specified luminous intensity distribution characteristics.

In the state where the cover 14 is attached to the housing 11, the attachment part 67 of the cover 14 is positioned in the vicinity of the support part 27 of the housing 11, that is, positioned within a range of 10° from the support part 27 in the peripheral direction. Thus, floating of a portion of the cover 14 facing the support part 27 can be prevented, and the cover 14 presses the flange part 56 of the lens 13 to the support part 27, and the lens 13 can be certainly fixed to the housing 11.

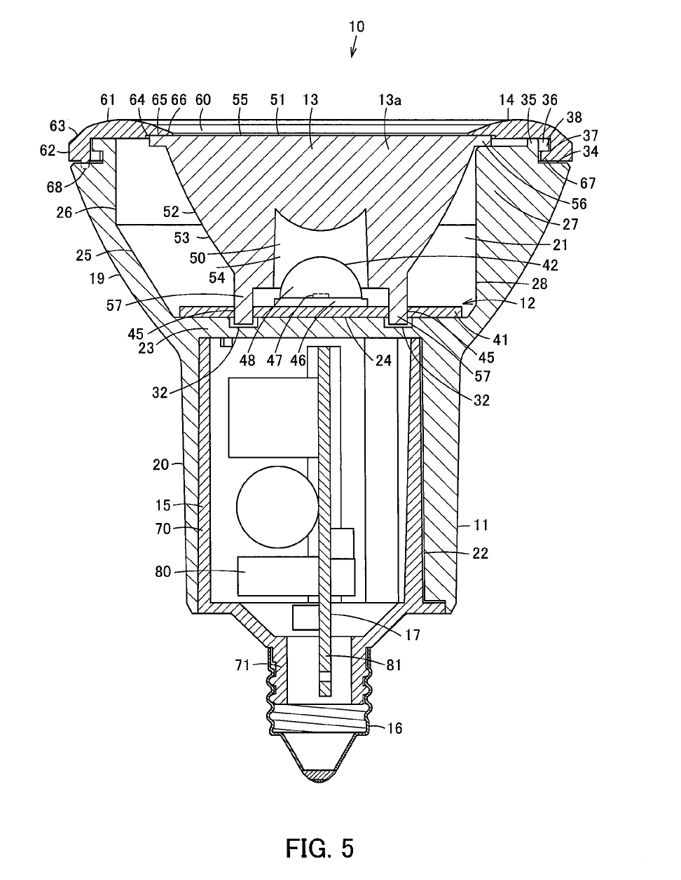

Next, FIG. 5 shows a second embodiment. Incidentally, the same components as those of the first embodiment are denoted by the same reference numerals, and a description thereof and a description of operation and effect are omitted.

A front surface part 61 of a cover 14 is formed in a convex curved surface shape in a diameter direction. When the front surface part 61 of the cover 14 has the convex curved surface shape in the diameter direction, as compared with the case where the front surface part 61 is flat, light incident on the cover 14 can be easily made to exit in a direction crossing the center axis direction of the lamp apparatus, and the light can be exited in a wide range from the cover 14.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp apparatus comprising:
a housing including a concave part opening at one end side, and a support part protruding into the concave part from an inner peripheral surface of the concave part;
a light-emitting module which includes a light-emitting element and a board on which the light-emitting element is mounted, and is disposed in the concave part;
a lens which includes a flange part located at a peripheral part at one end side and arranged on one end side of the support part, is arranged in the concave part and controls luminous intensity distribution of light incident from the light-emitting element;
an annular cover which holds the flange part of the lens between itself and the support part and is attached to the housing;
a power-supply part arranged at the other end side of the housing; and
a lighting circuit arranged between the housing and the power-supply part.

2. The apparatus according to claim 1, wherein the cover includes an attachment part attached to the housing in a vicinity of the support part.

3. The apparatus according to claim 1, wherein
the lens includes a leg part protruding from the other end side of the lens, and
the board includes a through hole through which the leg part passes.

4. The apparatus according to claim 3, wherein the housing includes an escape part in which the leg part passing through the board is arranged in a non-contact state.

5. The apparatus according to claim 3, wherein the leg part is provided on the lens at a position of 60° or more relative to an optical axis of the light-emitting element.

6. The apparatus according to claim 1, wherein an inner peripheral part of the cover is arranged nearer to a center side than the flange part of the lens.

7. The apparatus according to claim 1, wherein the support part protrudes from a plurality of places on the inner peripheral surface of the concave part toward a center of the concave part.

8. The apparatus according to claim 1, wherein the cover includes an inclined surface which is formed on an inner peripheral part of the cover and expands toward a light irradiation direction.

9. The apparatus according to claim 1, wherein a front surface part of the cover has a convex curved surface shape in a diameter direction.

10. A luminaire comprising:
a socket; and
a lamp apparatus according to claim 1, wherein the power-supply part is mounted in the socket.
